(19) United States
(12) Patent Application Publication
(10) Pub. No.: US 2011/0039107 A1
(43) Pub. Date: Feb. 17, 2011

(54) FILM PRIMER WITH IMPROVED ADHESION

(76) Inventors: Andre Buchholz, Ritterhude (DE); Martin Demmig, Quickborn (DE)

Correspondence Address: BUCHANAN, INGERSOLL & ROONEY PC, POST OFFICE BOX 1404, ALEXANDRIA, VA, 22313-1404, US

(21) Appl. No.: 12/745,672

(22) PCT Filed: Nov. 28, 2008
(86) PCT No.: PCT/EP08/66464

§ 371 Date: Oct. 8, 2010

(30) Foreign Application Priority Data
Nov. 30, 2007 (EP) 07122022.2

(51) Int. Cl. B32B 27/40; C08K 5/3412; B05D 3/00; C09J 5/02

(52) U.S. Cl. 428/412; 524/86; 427/331; 428/423.1; 428/424.6; 428/424.4; 428/424.8; 428/423.3; 428/423.5; 428/423.7; 156/314

(57) ABSTRACT

A primer composition is disclosed which includes a compound of the formula (I) and a polymer P, which has at least one nucleophilic functional group per molecule, for gluing plastic films. The primer compositions of this type are suitable for laminating molded parts and components, for example by vacuum deep-drawing. Exemplary compositions can provide improved adhesion and stretching ability of the primer on the plastic film, such that little or no cracking, which leaves behind traces of the film top side, occurs in the primer layer.

### RELATED APPLICATIONS

This application claims priority as a continuation application under 35 U.S.C. §120 to PCT/EP2008/066464, which was filed as an International Application on Nov. 28, 2008 designating the U.S., and which claims priority to European Application 07122022.2 filed in Europe on Nov. 30, 2007. The entire contents of these applications are hereby incorporated by reference in their entireties.

### FIELD

The disclosure relates to the field of primers for gluing plastic films.

### BACKGROUND INFORMATION

In the gluing of plastic films such as so-called lamination, primers are used as adhesion promoters between film and adhesive. In addition to improving adhesion, the primer layer also, on the one hand, can serve as a plasticizer block between plastic film and adhesive and, on the other hand, can prevent binding between the front and back sides of the plastic film in the film roll. In this case, systems based on both solvent and water are known.

A drawback of known water-based systems is that the adhesion and the stretching ability of the primer layer on the plastic film can be unsatisfactory. For example, in applications where the film is precoated with a primer and where it is used for laminating molded parts and components, for example by vacuum deep-drawing, unsatisfactory adhesion can lead to a considerable cracking in the primer layer. At the points where the primer cracks or becomes detached from the film, the cracks propagate in the plastic film, particularly in foam films. While these cracks develop on the back side of the film, they are also still evidenced on the visible side of the film as contrast images, which represents an optical detraction.

### SUMMARY

A primer composition Z for coating or gluing plastic films is disclosed, the primer composition comprising:
a) a compound of formula (I)

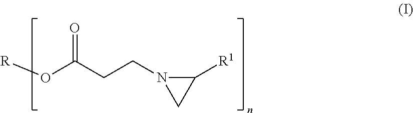

wherein radical R stands for an n-value aliphatic hydrocarbon radical with 2 to 15 C atoms;
the radical R¹ stands for a hydrogen atom or for a methyl group;
and
n stands for a value of 2 to 4;
and
b) at least one polymer P, which has at least one nucleophilic functional group.

A method of gluing two substrates S1 and S2 is disclosed comprising:
i) applying a primer composition Z, having:
   a) a compound of formula (I)

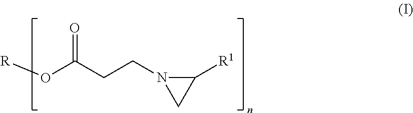

wherein radical R stands for an n-value aliphatic hydrocarbon radical with 2 to 15 C atoms;
the radical R¹ stands for a hydrogen atom or for a methyl group;
and
n stands for a value of 2 to 4;
and
b) at least one polymer P, which has at least one nucleophilic functional group;
on a substrate S1 that is to be glued;
ii) applying an adhesive on the primer composition Z that is located on the substrate S1;
iii) contacting the adhesive with a second substrate S2;
Or
i′) applying the primer composition Z on a substrate S1 that is to be glued;
ii′) applying an adhesive on a substrate S2;
iii′) contacting the adhesive with the primer composition Z that is located on the substrate S1;
Or
i″) applying the primer composition Z on a substrate S1 that is to be glued;
ii″) applying an adhesive to the primer composition Z that is located on the substrate S1;
iii″) applying an adhesive on a substrate S2;
iv″) contacting the adhesive on the primer composition Z that is located on the substrate S1 with the adhesive that is located on the substrate S2;
whereby at least one of substrates S1 or S2 is a plastic film.

A method for the production of a plastic film is disclosed that is coated with a primer composition Z and that comprises:
i′″) applying the primer composition Z on a plastic film, the primer composition including:
   a) a compound of formula (I)

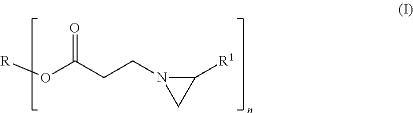

wherein radical R stands for an n-value aliphatic hydrocarbon radical with 2 to 15 C atoms;
the radical R¹ stands for a hydrogen atom or for a methyl group;
and
n stands for a value of 2 to 4;
and
b) at least one polymer P, which has at least one nucleophilic functional group; and
ii′″) aerating the primer composition Z with formation of an aerated primer composition and/or an at least partially cross-linked primer composition.

A plastic film is disclosed, which is produced according to a method comprising:
i′″) applying the primer composition Z on a plastic film, the primer composition including:
   a) a compound of formula (I)

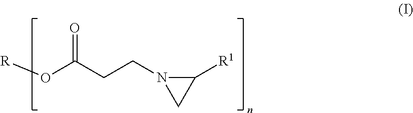

wherein radical R stands for an n-value aliphatic hydrocarbon radical with 2 to 15 C atoms;
the radical R¹ stands for a hydrogen atom or for a methyl group;
and
n stands for a value of 2 to 4;
and
b) at least one polymer P, which has at least one nucleophilic functional group; and
ii′″) aerating the primer composition Z with formation of an aerated primer composition and/or an at least partially cross-linked primer composition.

### DETAILED DESCRIPTION

A primer composition is disclosed for gluing of plastic films that can exhibit improved adhesion and stretching ability in plastic films relative to known compositions.

For example, compounds of formula (I) as disclosed herein for use in primer compositions to glue plastic films can surprisingly result in improved adhesion and higher stretching ability of the primer on the plastic film, by which during their gluing, the cracking in the primer layer can be prevented. As a result, for example when laminating molded parts and components, contrast images that detract from the optical appearance of the laminated part can be prevented.

In addition, exemplary primer compositions according to the disclosure can have the advantage that they can be applied to a plastic film and when the film is unrolled for storage, they can result in a slighter binding of the front and back side in the film roll.

An exemplary primer composition Z as disclosed herein comprises at least

a) one compound of formula (I)

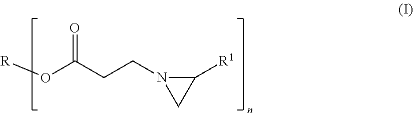

whereby the radical R stands for an n-value aliphatic hydrocarbon radical with 2 to 15 C atoms, which optionally has heteroatoms; the radical R¹ stands for a hydrogen atom or for a methyl group, and n stands for a value of 2 to 4;

and

b) at least one polymer P, which has at least one nucleophilic functional group; as primer for the coating and gluing of plastic films.

In this document, substance names that begin with “poly,” such as polyol or polyisocyanate, refer to substances that formally contain two or more functional groups per molecule that occur in their name.

In this document, on the one hand, the term “polymer” encompasses a population of macromolecules that are chemically uniform but are different relative to the degree of polymerization, molecular weight and chain length, and the population was produced by a polyreaction (polymerization, polyaddition, polycondensation). On the other hand, the term also encompasses derivatives of such a population of macromolecules from polyreactions (e.g., compounds that were obtained by reactions, such as, for example, additions or substitutions of functional groups on specific macromolecules, and that can be chemically uniform or chemically inconsistent). In addition, the term also encompasses so-called prepolymers (e.g., reactive oligomeric prepolymers whose functional groups are involved in the creation of macromolecules).

The term “polyurethane polymer” encompasses all polymers that are produced according to the so-called diisocyanate-polyaddition method. This includes all those polymers that are almost or completely free of urethane groups. Examples of polyurethane polymers are polyether polyurethanes, polyester polyurethanes, polyether polyureas, polyureas, polyester polyureas, polyisocyanurates and polycarbodiimides.

For example, flexible, large-area plastics in a thickness of 0.05 to 5 mm are defined as “plastic films,” which can be rolled up. Thus, in addition to “films” in the strict sense of thicknesses of less than 1 mm, sealing strips are defined, as they are used for example in sealing tunnels, roofs or swimming pools in a thickness of, for example, 1 to 3 mm, in special cases even in a thickness of up to at most about 5 mm. Such plastic films can be produced by coating, pouring, calendaring or extrusion and are commercially available in rolls or are produced on the spot. They can be created in one layer or several layers.

The term “primer” is known to those skilled in the art and refers in this document to a thin layer of, for example, thinner than 1 mm (e.g., between 1 and 200 μm, preferably between 1 and 100 μm), which is applied to the surface of a substrate, and, if desired, the primer is brought into contact with an adhesive after aeration, whereby the primer can lead to an improvement of the adhesion of the adhesive to the substrate.

In this document, “aeration” is defined as a drying out of a primer composition after application, whereby the solvent or the dispersing agent is completely or at least for the most part (i.e., substantially) evaporated.

“Volatile organic compounds,” also VOC, are defined in this document as organic compounds that have a boiling point of less than 250° C. at normal pressure or a vapor pressure of greater than 0.1 mbar at 20° C.

A temperature of 23° C. is referred to as “room temperature.”

In the compound of formula (I), the radical R can, for example, stand for an esterified or partially esterified radical of a polyol, which is selected, for example, from the group that consists of glycerol, 1,1,1-trimethylolethane, pentaerythritol, 1,1,1-trimethylolpropane and di(trimethylolpropane).

If the radical R stands for a completely esterified radical of a polyol, it corresponds, for example, to a radical that is selected from the group that consists of

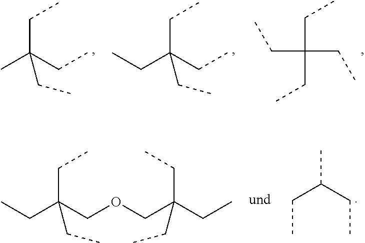

The dotted lines in the formulas of this document in each case represent the bond between the respective substituents and the related molecule radical.

n represents, for example, the value 3, and the radical R stands for a radical of formula (II) or formula (III).

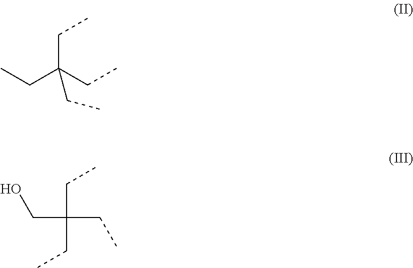

Exemplary preferred compounds of formula (I) are selected from the group that consists of trimethylolpropane-tris-((2-methyl)aziridin-1-yl)-propionate, trimethylolpropane-tris-3-(aziridin-1-yl)propionate and pentaerythritol-tris-3-(aziridin-1-yl)propionate.

Such compounds of formula (I) are commercially available, for example, under the trade names XAMA® 2, XAMA® 7 and XAMA® 220 from the company Bayer Material Science LLC, USA, or under the trade names Chemitite® PZ from the company Nippon Shokubai Co., LTD, Japan.

Compounds of formula (I) can be produced, for example, from a re-esterification of methyl-3-(2-methylaziridin-1-yl)propionate or methyl-3-(aziridin-1-yl)propionate with a polyol of formula (IV) with use of catalysts, in particular tertiary amines, titanium (IV) or tin (IV) compounds.

ROH)ₙ (IV)

For example, compounds of formula (I) can also be produced by Michael addition of 2-methylaziridine or aziridine to a compound of formula (V).

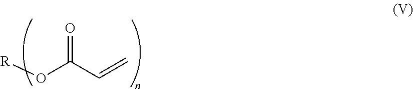

The radical R and the value n in the compounds of formula (IV) and (V) have already been described.

The proportion of the compound of formula (I) can be, for example, 0.1 to 3% by weight, in particular 0.2 to 2% by weight, preferably 0.3 to 0.7% by weight, relative to the total weight of the primer composition Z.

The polymer P can have at least one nucleophilic functional group that is selected, for example, from the group that consists of the hydroxyl group, carboxyl group, sulfonate group and phosphate group.

The polymer P can, for example, be a polyurethane PUR, in particular a polyester polyurethane, or a poly(meth)acrylate PAC.

Polyurethanes PUR, which have at least one nucleophilic group, can be produced, for example, from at least one polyisocyanate and at least one polyol as well as at least one monomer M1, which has at least one isocyanate group or a group that is reactive compared to isocyanate groups and, moreover, at least one nucleophilic functional group.

As polyisocyanates, commercially available aliphatic, cycloaliphatic or aromatic polyisocyanates, such as diisocyanates, can be used.

As polyols, for example polyester or polyether polyols, polyester or polyether diols, are suitable. In addition, low-molecular divalent or multivalent alcohols, such as, for example, 1,2-ethanediol, 1,3- and 1,4-butanediol, 1,2- and 1,3-propanediol, neopentyl glycol, diethylene glycol, triethylene glycol, the isomeric dipropylene glycols and tripropylene glycols, the isomeric pentanediols, hexanediols, heptanediols, octanediols, nonanediols, decanediols, undecanediols, 1,3- and 1,4-cyclohexane-dimethanol, hydrogenated bisphenol A, dimeric fatty alcohols, 1,1,1-trimethylolethane, 1,1,1-trimethylolpropane, glycerol, pentaerythritol, sugar alcohols, such as xylitol, sorbitol or mannitol, sugars such as saccharose, other polyhydric alcohols, low-molecular alkoxylating products of the above-mentioned divalent and multivalent alcohols, as well as mixtures of the above-mentioned are suitable.

Suitable monomers M1 can have at least one carboxyl group and/or one sulfonate group. For example, the monomer M1 can be an aminocarboxylic acid, a hydroxycarboxylic acid, in particular a dihydroxyalkylcarboxylic acid, such as, for example, dimethylolpropionic acid or a diol carboxylic acid that is similar in structure thereto, or a sulfonic acid that has NCO-reactive groups, such as, for example, a dihydroxysulfonic acid. The monomer M1, which has a sulfonate group, can be the sodium salt of N-(2-aminoethyl)-2-aminoethanesulfonic acid.

It has been shown that especially suitable polyurethanes are those whose content is included herewith as reference, as they are described, for example, as “polymer (PII)” in DE 100 00 656 A1 or WO 01/34559 A1, or as “polyurethane” in DE 195 21 500 A1, the disclosures of which are hereby incorporated by reference in their entireties.

Poly(meth)acrylates PAC, which have at least one nucleophilic group can be produced, for example, from at least one (meth)acrylate monomer as well as at least one monomer M2, which can be polymerized with the (meth)acrylate monomer and, moreover, has at least one nucleophilic functional group. For example, such poly(meth)acrylates are copolymers that consist of at least one (meth)acrylate monomer, which is selected from the group that consists of methyl(meth)acrylate, butyl(meth)acrylate, ethylhexyl(meth)acrylate, ethylene glycol di(meth)acrylate, tetrahydrofurfuryl(meth)acrylate, isobornyl(meth)acrylate and butanediol di(meth)acrylate; and at least one unsaturated carboxylic acid, in particular (meth)acrylic acid, maleic acid, fumaric acid, crotonic acid or the like, a (meth)acrylamide or a (meth)acrylic acid ester, which has a hydroxyl group, in particular hydroxyalkyl(meth)acrylate such as hydroxybutyl acrylate (HBA), hydroxybutyl methacrylate (HBMA), hydroxypropyl acrylate (HPA), hydroxypropyl methacrylate (HPMA), hydroxyethyl acrylate (HEA) or hydroxyethyl methacrylate (HEMA) or a partial ester of a polyol, preferably glycerol or trimethylol propane, with (meth)acrylic acid.

The primer composition Z can be an aqueous polymer dispersion, whereby the polymer P is present as solid, and the proportion of the polymer P is, for example, 15 to 55% by weight, in particular 25 to 50% by weight, preferably 35 to 45% by weight, relative to the total weight of the primer composition Z.

The aqueous polymer dispersion in this case is, for example, a mixture that consists of an aqueous polyurethane dispersion, comprising at least one polyurethane PUR, and an aqueous poly(meth)acrylate dispersion, comprising at least one poly(meth)acrylate PAC, as it has been previously described in each case.

The proportion of the aqueous polyurethane dispersion is, for example, 10 to 50% by weight, in particular 20 to 40% by weight, preferably 33 to 36% by weight, relative to the total weight of the primer composition Z. In this case, the solid content of the aqueous polyurethane dispersion (e.g., the proportion of the polyurethane PUR), is for example 35 to 55% by weight, in particular 40 to 50% by weight, preferably 44 to 56% by weight, relative to the total weight of the aqueous polyurethane dispersion.

The proportion of the aqueous poly(meth)acrylate dispersion is, for example, 40 to 80% by weight, in particular 50 to 70% by weight, preferably 60 to 66% by weight, relative to the total weight of the primer composition Z. The solid content of the aqueous poly(meth)acrylate dispersion (e.g., the proportion of the poly(meth)acrylate PAC), is in this exemplary case 30 to 50% by weight, in particular 35 to 40% by weight, preferably 37 to 38% by weight, relative to the total weight of the aqueous poly(meth)acrylate dispersion.

The primer composition Z can be a two-component composition, whereby the two components A and B are stored separately from one another up until the application and are mixed with one another only just briefly before. For example, the first component A contains at least one polymer P, and the second component B contains at least one compound of formula (I).

In addition, the primer composition Z can also comprise other components. These an be selected for example from the group that consists of stabilizers, emulsifiers, thickening agents, solvents, rheology additives, preservatives, antioxidants, pesticides, fungicides, pigments, dyes, wetting agents, foam inhibitors, dulling agents, neutralizing agents, and fillers.

In this case, those skilled in the art will appreciate that the additional components within one component of the primer composition can be to be selected in such a way that they do not react together in a way by which the shelf life of these components is impaired.

If the primer composition Z is an aqueous polymer dispersion, in principle such stabilizers as are known for use in aqueous dispersions are suitable. It has been shown, however, that the use of, for example, wetting agents, cellulose, polyvinyl alcohol, polyvinyl pyrrolidone as well as mixtures thereof clearly improves the shelf life of polymer dispersions.

In addition, the primer composition Z can have, for example, less than 5% by weight, in particular 0 to 2% by weight, preferably 0 to 1% by weight, mostly preferably 0% by weight, in each case relative to the total weight of the primer composition Z, of organic compounds, which have a boiling point of less than 250° C. at normal pressure or a vapor pressure of greater than 0.1 mbar at 20° C., the above-mentioned VOCs. This can be very advantageous, for example, from the standpoint of ecology, health and safety.

Exemplary embodiments encompass the use of a primer composition Z as disclosed herein as a primer for dispersion adhesives.

The use of a primer composition Z as disclosed herein can be suitable as a primer for the coating and gluing of plastic films, whereby the latter are created from a thermoplastic plastic, such as polyvinyl chloride (PVC), in particular soft PVC, ethylene/vinyl acetate copolymer (EVA), or thermoplastic polyolefins (TPO), acrylonitrile/styrene/acrylic acid ester copolymer (ASA), polyurethane (PUR), polyamide (PA), poly(meth)acrylates, polycarbonates, polyethylene terephthalate (PET) or their plastic alloys.

PVC films, such as PVC foam films, are especially preferred.

The primer composition Z is most preferably suitable for plastic films that are used for the lamination of molded parts and components, in particular by vacuum deep-drawing.

The application of the primer composition Z can be performed by means of towels, felt, rollers, sponge, paintbrush, coating knife, spraying, coating, rolling, pouring, stamping, dip-coating or the like and can be carried out both manually and by means of robots.

In another aspect, the disclosure comprises a method of gluing two substrates S1 and S2 that comprises:
i) Application of a primer composition Z according to the preceding description on a substrate S1 that is to be glued;
ii) Application of an adhesive to the primer composition Z that is located on the substrate S1;
iii) Bringing the adhesive into contact with a second substrate S2;

### Or

i′) Application of a primer composition Z according to the preceding description on a substrate S1 that is to be glued;
ii′) Application of an adhesive on a substrate S2;
iii′) Bringing the adhesive into contact with the primer composition Z that is located on the substrate S1;

### Or

i″) Application of a primer composition Z according to the preceding description on a substrate S1 that is to be glued;
ii″) Application of an adhesive on the primer composition Z that is located on the substrate S1;
ii″) Application of an adhesive on a substrate S2;
iii″) Bringing the adhesive on the primer composition Z that is located on the substrate S1 into contact with the adhesive that is located on the substrate S2.

In this case, at least one of the substrates S1 or S2 can be a plastic film, as it has been described previously.

After the application of the primer composition Z and before the application of the adhesive, if desired, the aeration of the primer composition Z can take place with the formation of an aerated primer composition and/or an at least partially cross-linked primer composition.

In addition, the disclosure also relates to a method for the production of a plastic film that is coated with a primer composition Z and that comprises:

i′″) Application of a primer composition Z according to the preceding description on a plastic film;

ii′″) Aeration of the primer composition Z with formation of an aerated primer composition and/or an at least partially cross-linked primer composition.

The aeration can be carried out by evaporation of air with or without aerating means. As aerating means, for example, a bellows, in particular an air bellows, can be used. The aeration can be carried out at room temperature or at an elevated temperature, for example a temperature of below 150° C. The aeration preferably takes place at a low temperature.

The disclosure also comprises a plastic film, as it has been described previously, which is coated with a primer composition Z, also described previously, and/or with an aerated primer composition and/or with an at least partially cross-linked primer composition.

The thus produced plastic film that is coated with a primer composition Z can now—if desired—be cut to length, beveled, rolled up or directly further processed. The rolls with the coated plastic films can be stored or transported, if necessary. It can be a significant advantage of the described plastic film that is coated with a primer composition Z that it can be rolled up without the use of separating paper intermediate lagers, since no binding of the rolled-up film occurs even after extended storage or transport times. Those skilled in the art will appreciate that it can nevertheless be advantageous under certain conditions to use intermediate layers of a separating paper. The plastic film can thus be coated, for example, by the film manufacturer and stored for an extended period and, if desired, delivered to the plant, which then glues this precoated film to a carrier. Despite this long time between coating and processing, a flawless adhesive bond can be ensured. This advantage can be especially important because in industry, such as in the manufacturing of automobiles, there is an observable trend in manufacturing “away from the conveyor belt to the supplier.” This trend is also continuing, for its part, between the direct supplier, for example of car doors, and their suppliers, for example of decorative materials.

In another aspect, the disclosure comprises the use of a plastic film that is coated with a primer composition Z, such as has been previously described for laminating components for vehicle interiors, especially instrument panels, door side panel coverings, center consoles, seat coverings, and the like.

In this case, the plastic film can be applied by vacuum deep-drawing or by press-lamination on the substrate.

During vacuum deep-drawing, the plastic film that is coated with a primer composition such as a decorative film that consists of an air-impermeable material, is stretched and heated in an airtight manner in a frame. In this state, the film is joined over a housing that is also airtight on the bottom that is located in or on the mold or the component to be laminated. This mold or this component is coated with an adhesive, such as a dispersion adhesive, which is aerated, if desired. When the air is suctioned off from this device, the plastic film now clings tightly to the underlying component under the atmospheric pressure that bears on its surface.

During press-lamination, a plastic film that is coated with a primer composition and that in contrast to the vacuum deep-drawing, however, does not necessarily have to be air-impermeable but rather can also comprise (e.g., consist of) an open-pore material, for example a PVC foam, is glued to the mold or the component to be laminated with fusing and pressing. During press-lamination, the adhesive can also be applied on the mold or the component and also on the plastic film, if desired.

### EXAMPLES

### Production of the Primer Composition

As component A′ of the primer composition, a composition that comprises an aqueous polyurethane dispersion DPUR, an aqueous poly(meth)acrylate dispersion DPAC, as well as a rheology additive (Borchi® Gel L 75 N, commercially available from the company Borchers GmbH, Germany), mixed together in the proportions by weight indicated in Table 1, was used both for Example 1 according to the disclosure and for Comparison Example 2.

An aqueous, anionic polyester polyurethane dispersion with a solid content of about 45% by weight, a pH of about 7, a viscosity at room temperature of 50 to 180 mPas (measured according to DIN EN ISO 3219, shear rate 250 s⁻¹) and a density of about 1.06 g/cm³ was used as an aqueous polyurethane dispersion DPUR.

An aqueous, anionic poly(meth)acrylate dispersion with a solid content of about 37% by weight, a pH of about 10, a viscosity at room temperature of about 30 mPas (measured according to DIN EN ISO 3219, shear rate 250 s⁻¹) and a density of about 1.03 g/cm³ was used as an aqueous poly(meth)acrylate dispersion DPAC.

A water-emulsifiable isocyanate (Desmodur® DN, commercially available from the company Bayer Material Science, Germany) was used as component B′ for Comparison Example 2. Trimethylolpropane-tris-3-(1-aziridinopropionate) was used as component B′ for Example 1 according to the disclosure.

Before use, the respective components A′ and B′ were mixed together according to the proportions by weight indicated in Table 1.

### Description of the Measuring Methods

Testing for Cracking: Tensile Test

The respective primer composition was applied by means of a coating knife in a layer thickness of 60 μm on a PVC foam film. The films were dried for one minute at a temperature of 120° C. in an oven and then stored for 24 hours at room temperature. Then, the film was cut into strips and subjected to a tensile test at 130° C., a traction speed of 50 mm/minute, and a maximum elongation of 100%. After the tensile test, the cracking was evaluated on the film side, which was coated with the primer composition. The cracking in the primer layer was evaluated visually.

Testing for Cracking: Deep-Drawing Test

In a first test for determining the cracking in the primer layer during deep-drawing, one plastic film each, coated with a primer composition according to Examples 1 and 2 (for comparison), was heated to a temperature of 150° C. and then run over the upper, large opening of a funnel. At the lower opening, i.e., on the neck, of the funnel, a vacuum was applied, whereupon the plastic film was deep-drawn. The cracking in the primer layer was evaluated visually.

In a second deep-drawing test, one plastic film each, coated with a primer composition according to Examples 1 and 2 (for comparison), was heated to a temperature of 150° C. and deep-drawn over an acrylonitrile/butadiene/styrene test piece coated with a dispersion adhesive. The cracking was evaluated visually based on the contrast images on the film top.

Testing of the Blocking Strength of the Primer

According to the above-described method, test strips with dimensions of 5×10 cm were produced and placed on one another in such a way that the front and back sides of the film were in contact with one another. The samples were loaded with a 2.5 kg material and stored in this state for 24 hours in the drying oven at a temperature of 80° C. After the samples were cooled to room temperature, the separating force and the peeling force of the films were measured in a T-peeling test (180° peeling test) at room temperature and a traction speed of 200 mm/minute.

TABLE 1
Primary Compositions and Test Results

| | Contents [% by Weight] | 1 | 2 (For Comparison) |
|---|---|---|---|
| Component A′ | Polyurethane | 34 | 34 |
| | Dispersion DPUR | | |
| | Poly(meth)acrylate | 63 | 63 |
| | Dispersion DPAC | | |
| | Rheology Additive | 3 | 3 |
| Component B′ | Desmodur ® DN | 5 | |
| | Trimethylolpropane- | | 0.5 |
| | tris-3-(1-aziridino- | | |
| | propionate) | | |
| Visual evaluation of | | Strong cracking; | No cracking; |
| the cracking after | | partial contrast | homogeneous film |
| tensile and deep- | | images on the | bottom and top, no |
| drawing tests | | film top, partial | dissolution of the |
| | | dissolution of | primer. |
| | | the primer. | |
| Blocking Strength | Film Thickness 1.2 mm | 0.32 | 0.41 |
| (Separating Force in | Film Thickness 3.2 mm | 1.23 | 1.16 |
| [N/5 cm]) | | | |

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A primer composition Z for coating or gluing plastic films, the primer composition comprising:
a) a compound of formula (I) 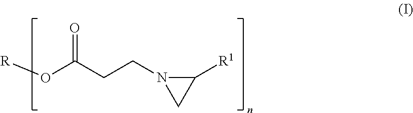
wherein radical R stands for an n-value aliphatic hydrocarbon radical with 2 to 15 C atoms;
the radical R¹ stands for a hydrogen atom or for a methyl group;
and
n stands for a value of 2 to 4;
and
b) at least one polymer P, which has at least one nucleophilic functional group.

2. The primer composition according to claim 1, wherein the radical R has heteroatoms and stands for an esterified or partially esterified radical of a polyol, which is selected from the group that consists of glycerol, 1,1,1-trimethylolethane, pentaerythritol, 1,1,1-trimethylolpropane and di(trimethylolpropane).

3. The primer composition according to claim 1, wherein the compound of formula (I) is selected from the group that consists of trimethylolpropane-tris-(1-(2-methyl)aziridino)-propionate, trimethylolpropane-tris-3-(1-aziridinopropionate) and pentaerythritol-tris-3-(1-aziridinopropionate).

4. The primer composition according to claim 1, wherein the proportion of the compound of formula (I) is 0.1 to 3% by weight relative to the total weight of the primer composition Z.

5. The primer composition according to claim 1, wherein the polymer P has at least one nucleophilic functional group, which is selected from the group that consists of the hydroxyl group, carboxyl group, sulfonate group and phosphate group.

6. The primer composition according to claim 1, wherein the polymer P is a polyurethane.

7. The primer composition according to claim 1, wherein the primer composition Z is an aqueous polymer dispersion, whereby the polymer P is present as a solid.

8. The primer composition according to claim 7, wherein a proportion of the polymer P is 15 to 55% by weight, relative to the total weight of the primer composition Z.

9. The primer composition according to claim 7, wherein the aqueous polymer dispersion comprises a mixture that consists of an aqueous polyurethane dispersion and an aqueous poly(meth)acrylate dispersion.

10. The primer composition according to claim 9, wherein the proportion of the aqueous polyurethane dispersion is 10 to 50% by weight, and the proportion of the aqueous poly(meth)acrylate dispersion is 40 to 80% by weight, in each case relative to the total weight of the primer composition Z.

11. The primer composition according to claim 9, wherein the solid content of the aqueous polyurethane dispersion is 35 to 55% by weight relative to the total weight of the aqueous polyurethane dispersion.

12. The primer composition according to claim 9, wherein the solid content of the aqueous poly(meth)acrylate dispersion is 30 to 50, relative to the total weight of the aqueous poly(meth)acrylate dispersion.

13. The primer composition according to claim 1, wherein the primer composition Z is a two-component composition, whereby
the first component A contains at least one polymer P; and
the second component B contains at least one compound of formula (I).

14. The primer composition according to claim 1, wherein the primer composition Z comprises at least one rheology additive.

15. The primer composition according to claim 1, wherein the primer composition Z is less than 5% by weight relative to the total weight of the primer composition Z, of organic compounds, which have a boiling point of less than 250° C. at normal pressure or a vapor pressure of greater than 0.1 mbar at 20° C.

16. The primer composition according to claim 1, in combination with a plastic film created from a thermoplastic plastic.

17. The primer composition according to claim 16, wherein the plastic film is a PVC foam film.

18. Method of gluing two substrates S1 and S2 comprising:
i) applying a primer composition Z, having:
a) a compound of formula (I) 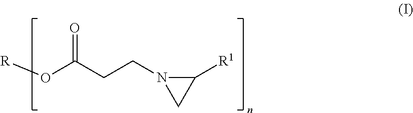
wherein radical R stands for an n-value aliphatic hydrocarbon radical with 2 to 15 C atoms;
the radical R¹ stands for a hydrogen atom or for a methyl group;
and
n stands for a value of 2 to 4;
and
b) at least one polymer P, which has at least one nucleophilic functional group; on a substrate S1 that is to be glued;
ii) applying an adhesive on the primer composition Z that is located on the substrate S1;
iii) contacting the adhesive with a second substrate S2;
Or
i′) applying the primer composition Z on a substrate S1 that is to be glued;
ii′) applying an adhesive on a substrate S2;
iii′) contacting the adhesive with the primer composition Z that is located on the substrate S1;
or
i″) applying the primer composition Z on a substrate S1 that is to be glued;
ii″) applying an adhesive to the primer composition Z that is located on the substrate S1;
iii″) applying an adhesive on a substrate S2;
iv″) contacting the adhesive on the primer composition Z that is located on the substrate S1 with the adhesive that is located on the substrate S2;
whereby at least one of substrates S1 or S2 is a plastic film.

19. Method according to claim 18, comprising:
forming, after the application of the primer composition Z and before the application of the adhesive, an aerated primer composition and/or an at least partially cross-linked primer composition for aeration of the primer composition Z.

20. Method according claim 18, wherein at least one of the substrates S1 or S2 is a plastic film that is created from a thermoplastic plastic selected from a group consisting of polyvinyl chloride (PVC), ethylene/vinyl acetate copolymer (EVA), and thermoplastic polyolefins (TPO), acrylonitrile/styrene/acrylic acid ester copolymer (ASA), polyurethane (PUR), polyamide (PA), poly(meth)acrylates, polycarbonates, polyethylene terephthalate (PET) and their plastic alloys.

21. Method according to claim 18, wherein the plastic film is a PVC film.

22. Method for the production of a plastic film that is coated with a primer composition Z and that comprises:
i′″) applying the primer composition Z on a plastic film, the primer composition including:
a) a compound of formula (I) 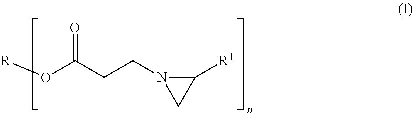
wherein radical R stands for an n-value aliphatic hydrocarbon radical with 2 to 15 C atoms;
the radical R¹ stands for a hydrogen atom or for a methyl group;
and
n stands for a value of 2 to 4;
and
b) at least one polymer P, which has at least one nucleophilic functional group; and
ii′″) aerating the primer composition Z with formation of an aerated primer composition and/or an at least partially cross-linked primer composition.

23. A plastic film, which is produced according to a method comprising:
i′″) applying the primer composition Z on a plastic film, the primer composition including:
a) a compound of formula (I) 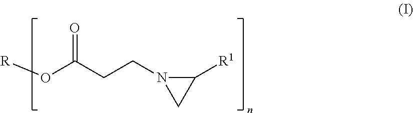
wherein radical R stands for an n-value aliphatic hydrocarbon radical with 2 to 15 C atoms;
the radical R¹ stands for a hydrogen atom or for a methyl group;
and
n stands for a value of 2 to 4;
and
b) at least one polymer P, which has at least one nucleophilic functional group; and
ii′″) aerating the primer composition Z with formation of an aerated primer composition and/or an at least partially cross-linked primer composition.

24. The plastic film according to claim 23, wherein the plastic film is created from a thermoplastic plastic selected from a group consisting of polyvinyl chloride (PVC), ethylene/vinyl acetate copolymer (EVA), and thermoplastic polyolefins (TPO), acrylonitrile/styrene/acrylic acid ester copolymer (ASA), polyurethane (PUR), polyamide (PA), poly(meth)acrylates, polycarbonates, polyethylene terephthalate (PET), and their plastic alloys.

25. The plastic film according to claim 23, wherein the plastic film is a PVC film.

26. The method according to claim 18, comprising:
laminating components for vehicle interiors with the primer composition.

27. The primer composition according to claim 1, wherein the proportion of the compound of formula (I) is 0.3 to 0.7% by weight relative to the total weight of the primer composition Z.

28. The primer composition according to claim 7, wherein a proportion of the polymer P is 35 to 45% by weight, relative to the total weight of the primer composition Z.

29. The primer composition according to claim 9, wherein the proportion of the aqueous polyurethane dispersion is 33 to 36% by weight, and the proportion of the aqueous poly(meth)acrylate dispersion is 60 to 66% by weight, in each case relative to the total weight of the primer composition Z.

30. The primer composition according to claim 9, wherein the solid content of the aqueous polyurethane dispersion 44 to 56% by weight, relative to the total weight of the aqueous polyurethane dispersion.

31. The primer composition according to claim 9, wherein the solid content of the aqueous poly(meth)acrylate dispersion is 37 to 38%, relative to the total weight of the aqueous poly(meth)acrylate dispersion.

32. The primer composition according to claim 1, wherein the primer composition Z is less than 0% by weight relative to the total weight of the primer composition Z, of organic compounds, which have a boiling point of less than 250° C. at normal pressure or a vapor pressure of greater than 0.1 mbar at 20° C.
